(19) United States
(12) Patent Application Publication
(10) Pub. No.: US 2025/0292574 A1
(43) Pub. Date: Sep. 18, 2025

(54) SCENE PARSING

(71) Applicant: International Business Machines Corporation, Armonk, NY (US)

(72) Inventors: Zhenfang Chen, Cambridge, MA (US); Yikang Shen, Cambridge, MA (US); Chuang Gan, Cambridge, MA (US); Kaizhi Qian, Champaign, IL (US)

(73) Assignee: International Business Machines Corporation, Armonk, NY (US)

(21) Appl. No.: 18/603,400

(22) Filed: Mar. 13, 2024

(51) Int. Cl. G06V 20/40; G06V 10/74; G06V 10/774

(52) U.S. Cl. CPC G06V 20/49; G06V 10/761; G06V 10/7753

(57) ABSTRACT

An embodiment partitions, using a trained image segmentation model, an input image into a plurality of patches. An embodiment generates, using a vision transformer model, a plurality of patch embeddings, each patch embedding comprising a multidimensional numerical representation of a patch in the plurality of patches. An embodiment generates, using a trained patch-label similarity model, a plurality of word embeddings corresponding to the plurality of patch embeddings. An embodiment generating, using a trained label prediction model and the plurality of word embeddings, a text label corresponding to the input image.

### BACKGROUND

The present invention relates generally to image analysis. More particularly, the present invention relates to a method, system, and computer program for scene parsing.

Scene parsing refers to a process of assigning a semantic label (e.g., person, vehicle, tree, or animal) to a portion of a scene (i.e., an image or a video frame). Optionally, scene parsing also refers to labelling a relationship between labelled entities within a scene (e.g., an animal jumping towards a ball, a person on a bicycle). Optionally, scene parsing also refers to generating a scene graph, a directed-graph-based abstract representation of objects and their relations within a scene. Typically, in a scene graph, each node denotes an object with a semantic label, and each directed edge denotes the relation between a pair of objects with a predicate label. Scene parsing is performed by a scene parser. Scene parsing results are useful in a variety of downstream image processing tasks, such as adjusting a prompt used in model-based image generation by analyzing a result of a previous iteration of the image generation, route planning and obstacle avoidance for robots and autonomous vehicles, annotating an image database for use in training a machine learning model to perform image classification, object recognition, and other image processing tasks, and the like.

The illustrative embodiments recognize that one existing method of scene parsing is bounding box based. A bounding box delineates a portion of an image being parsed. In particular, the method includes generating bounding box proposals by a pre-trained detector, labelling the proposals by classifying them into one of a pre-defined set of object classifications, and labelling relationships between proposals by classifying them into one of a pre-defined set of relationship classifications. Another existing method of scene parsing involves training, using supervised learning, a model to perform image segmentation by associating pixels with an object, and training a relationship model to predict relationships between groups of pixels. However, existing methods learn segmentation and relation prediction from manually-annotated training datasets. Building manually-annotated training datasets is extremely labor-intensive, making it difficult to scale up a scene parser to interpret more complex scenes, thus significantly limiting generalizability and application to real world image analysis tasks. Thus, the illustrative embodiments recognize that there is an unmet need for an improve scene parsing, that is less reliant on manually-annotated training datasets than existing methods and scales to more complex scenes more efficiently than existing methods.

### SUMMARY

The illustrative embodiments provide for scene parsing. An embodiment includes partitioning, using a trained image segmentation model, an input image into a plurality of patches. The embodiment includes generating, using a vision transformer model, a plurality of patch embeddings, each patch embedding comprising a multidimensional numerical representation of a patch in the plurality of patches. The embodiment includes generating, using a trained patch-label similarity model, a plurality of word embeddings corresponding to the plurality of patch embeddings. The embodiment includes generating, using a trained label prediction model and the plurality of word embeddings, a text label corresponding to the input image. Thus, the embodiment provides scene parsing. Other embodiments of this aspect include corresponding computer systems, apparatus, and computer programs recorded on one or more computer storage devices, each configured to perform the actions of the embodiment.

In a further embodiment, the trained patch-label similarity model comprises a similarity matrix, a cell of the similarity matrix storing a pair-wise similarity score between a patch embedding and a word embedding. Thus, the embodiment provides additional detail of the trained patch-label similarity model used in scene parsing.

In a further embodiment, the pair-wise similarity score between a patch embedding and a word embedding is computed by analyzing a plurality of training images and corresponding training image captions. Thus, the embodiment provides additional detail of the pair-wised similarity score used in scene parsing.

An embodiment further includes partitioning a training image in the plurality of training images into a plurality of training patches; and generating, using the vision transformer model, a plurality of training patch embeddings, each training patch embedding comprising a multidimensional numerical representation of a training patch in the plurality of training patches. Thus, the embodiment provides additional detail of generating training patch embeddings used in scene parsing.

An embodiment further includes generating, from a training image caption corresponding to the training image, a caption graph, each node in the caption graph representing an object described in the training image caption, each edge in the caption graph representing a relationship between two objects represented by nodes in the caption graph; generating, from a caption embedding and a plurality of node embeddings, a plurality of word embeddings, the caption embedding comprising a multidimensional numerical representation of the training image caption, the plurality of node embeddings each comprising a multidimensional numerical representation of a node in the caption graph; and computing a pair-wise similarity score between a training patch embedding in the plurality of training patch embeddings and a word embedding in the plurality of word embeddings. Thus, the embodiment provides additional detail of computing a pair-wise similarity score used in scene parsing.

In a further embodiment, the trained label prediction model is trained using the plurality of training patch embeddings and the plurality of word embeddings. Thus, the embodiment provides additional detail of training a label prediction model used in scene parsing.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example configuration for scene parsing in accordance with an illustrative embodiment;

FIG. 3 depicts an example of scene parsing in accordance with an illustrative embodiment;

FIG. 4 depicts a continued example of scene parsing in accordance with an illustrative embodiment;

FIG. 5 depicts a continued example of scene parsing in accordance with an illustrative embodiment; and

FIG. 6 depicts a flowchart of an example process for scene parsing in accordance with an illustrative embodiment.

### DETAILED DESCRIPTION

The illustrative embodiments recognize that there is an unmet need for an improve scene parsing, that is less reliant on manually-annotated training datasets than existing methods and scales to more complex scenes more efficiently than existing methods.

The present disclosure addresses the deficiencies described above by providing a process (as well as a system, method, machine-readable medium, etc.) that uses a trained image segmentation model to partition an input image into a plurality of patches; uses a vision transformer model to generate a plurality of patch embeddings; uses a trained patch-label similarity model to generate a plurality of word embeddings corresponding to the plurality of patch embeddings; and uses a trained label prediction model and the plurality of word embeddings to generate a text label corresponding to the input image. Thus, the illustrative embodiments provide for scene parsing.

An illustrative embodiment receives a dataset of training images, each with an accompanying caption describing, in text form, a scene portrayed in a training image. For example, one training image might of a person on a bicycle, and the accompanying caption might be “person on a bicycle”.

An illustrative embodiment partitions a training image into a plurality of patches, or segments, or portions. The patches can have any two-dimensional shape, but do not overlap each other. To partition a training image, one embodiment uses an image segmentation model that has been pre-trained, using a presently available technique, to recognize objects in images, and group image pixels according to which object the pixels portray. To partition a training image, another embodiment uses an image segmentation model that has been both pre-trained to recognize objects in images, and group image pixels according to which object the pixels portray, as well as partially trained by an embodiment in a manner described elsewhere herein. To partition a training image, another embodiment, without access to a pre-trained or partially trained image segmentation model, partitions a training image into equal-sized patches, with a patch size or number of patches set according to a predefined parameter or a default. To partition a training image, another embodiment, without access to a pre-trained or partially trained image segmentation model, partitions a training image into randomly located patches, of a random size, where the random numbers are generated using a pseudo-random number generator, a presently available technique. Other techniques for partitioning a training image are also possible and contemplated within the scope of the illustrative embodiments.

An embodiment generates a plurality of patch embeddings. Each patch embedding is a multidimensional numerical representation, or vector, or embedding, of a patch in the plurality of patches of a training image. To generate a patch embedding corresponding to a patch, one embodiment uses a vision transformer model, a presently available technique, to encode data of the pixels in the patch (e.g., a red value, green value, and blue value if the pixels are in RGB format), as well as data of a position of the patch, and optionally additional data, into an embedding. To generate a patch embedding corresponding to a patch, another embodiment uses a trained convolutional neural network or another presently available technique.

An embodiment generates a caption embedding, a multidimensional numerical representation, or embedding, of a natural language caption accompanying the training image for which patch embeddings have been generated. Two non-limiting examples of presently available techniques to generate a caption embedding include using a trained sentence transformer model and converting words in the caption to word embeddings (using a presently available technique such as word2vec) and aggregating the word embeddings together into a caption embedding.

An embodiment also uses a presently available natural language parsing technique (e.g., a text relation preprocessor) to generate a graph of a natural language caption accompanying the training image for which patch embeddings have been generated. In the caption graph, each node represents an object or other entity described in the caption and each edge (connecting two nodes) represents a relationship between the objects represented by the nodes. An embodiment uses a presently available technique, such as a trained recurrent neural network, to generate one or more word embeddings from the caption embedding and a plurality of node embeddings. Each node embedding is a multidimensional numerical representation, or embedding, of a node in the graph (and hence represents an object described in the caption and present in the training image). Thus, the plurality of word embeddings represents the caption as a whole.

An embodiment trains a patch-label similarity model by computing a similarity between a patch embedding and one or more word embeddings representing graph nodes. One embodiment uses a cosine similarity, a presently available similarity metric, to compute a similarity between embeddings. Other embedding similarity metrics are also possible and contemplated within the scope of the illustrative embodiments. An embodiment stores similarities between patch and word embeddings in a similarity matrix. In the similarity matrix, rows represent patch embeddings, columns represent word embeddings, and a row-column intersection stores a similarity between the row's patch embedding and the column's word embedding. One embodiment learns the similarity matrix using a fine-grained contrastive learning strategy, using node embeddings as pseudo labels. A fine-grained contrastive learning strategy is a presently available technique that involves training a model to discern detailed correlations between specific image regions and corresponding textual descriptions without explicit region-level annotations, aiming to capture nuanced semantic alignments between localized visual features and textual cues and enhancing a model's capability to accurately align regions of interest in images with their relevant textual descriptions.

Using the similarity matrix, an embodiment merges patches that have corresponding node embeddings that are sufficiently similar to each other.

An embodiment uses a pre-trained transformer-based language model, a presently available technique, to train a label prediction model to generate a text label corresponding to the input image. In particular, during training an embodiment generates a prompt from a caption graph, and inputs the prompt to a pre-trained transformer-based language model used to train a label prediction model. The label prediction model takes patch embeddings as input and learns, using an auto-regressive generation process, to output text describing the image, including one or more object classes and object labels. Pseudo labels generated by similarity matching is used to supervise the label predictor during training.

An embodiment backpropagates the gradient from training the label prediction model to further fine-tune the pre-trained image segmentation model. An embodiment repeats the training image analysis, using additional training image/caption pairs, until the image segmentation model, patch-label similarity model, and label prediction model meet training completion criteria.

Once the image segmentation model, patch-label similarity model, and label prediction model meet training completion criteria, an embodiment enters an inference phase. In the inference phase, an input image is parsed without use of an accompanying caption. Instead, an embodiment uses the trained image segmentation model to partition an input image into a plurality of patches.

An embodiment generates a plurality of patch embeddings. Each patch embedding is a multidimensional numerical representation, or vector, or embedding, of a patch in the plurality of patches of the input image. To generate a patch embedding corresponding to a patch, one embodiment uses a vision transformer model, optionally further trained using a training process described herein.

An embodiment uses the trained patch-label similarity model to generate a plurality of word embeddings corresponding to the plurality of patch embeddings. The trained patch-label similarity model includes a similarity matrix, in which rows represent patch embeddings, columns represent word embeddings, and a row-column intersection stores a similarity between the row's patch embedding and the column's word embedding. Contents of the similarity matrix were learned during a training process described herein. Thus, an embodiment uses the learned contents of the similarity matrix to output a word embedding that is most similar to an input patch embedding. The word or phrase represented by the word is thus a label for the patch (and an object within the patch) represented by the patch embedding.

An embodiment uses a trained label prediction model (optionally further trained using a training process described herein) and the plurality of word embeddings to generate a text label corresponding to the input image. In particular, the trained label prediction model takes, as input, embeddings corresponding to the input image and outputs text describing the image, including one or more object classes and object labels.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

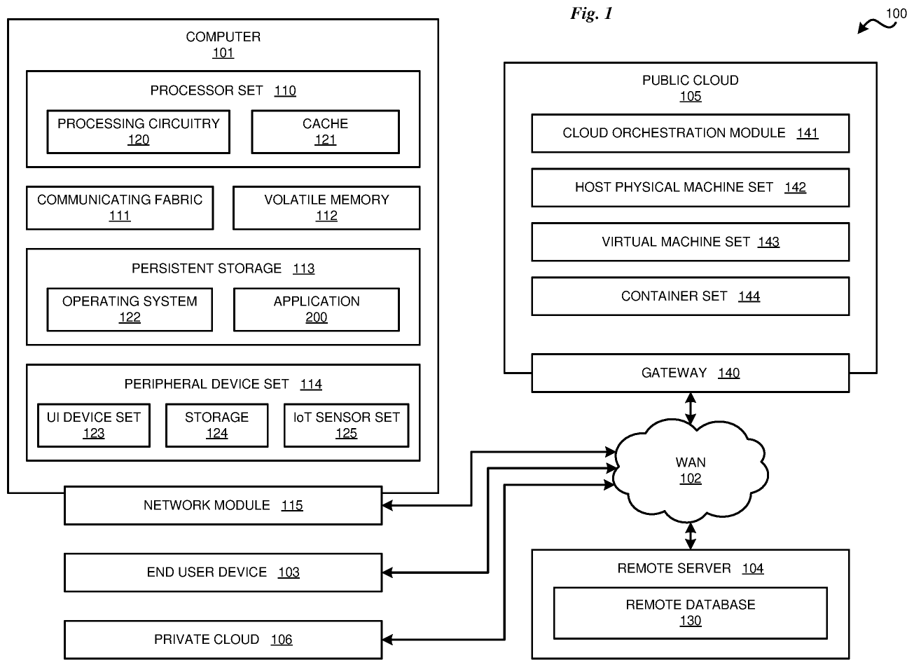

With reference to FIG. 1, this figure depicts a block diagram of a computing environment 100. Computing environment 100 contains an example of an environment for the execution of at least some of the computer code involved in performing the inventive methods, such as application 200 implementing scene parsing. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

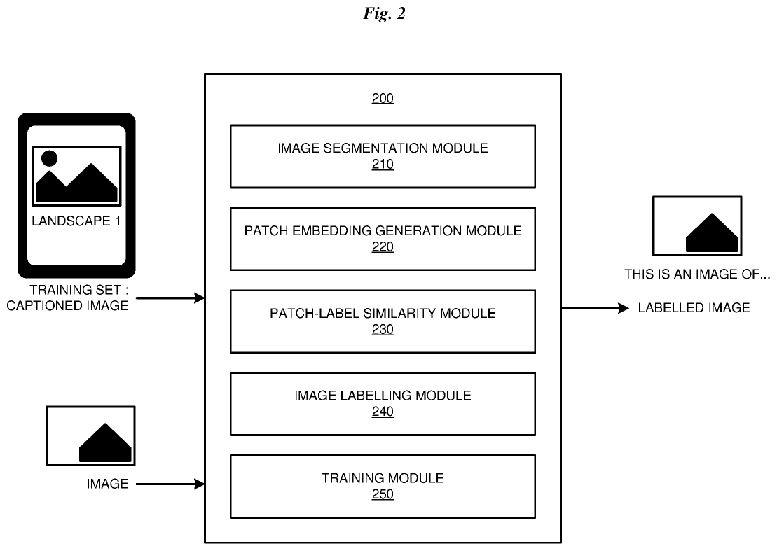

With reference to FIG. 2, this figure depicts a block diagram of an example configuration for scene parsing in accordance with an illustrative embodiment. Application 200 is the same as application 200 in FIG. 1.

In the illustrated embodiment, training module 250 receives a dataset of training images, each with an accompanying caption describing, in text form, a scene portrayed in a training image. For example, one training image might of a person on a bicycle, and the accompanying caption might be “person on a bicycle”.

Image segmentation module 210 partitions a training image into a plurality of patches, or segments, or portions. The patches can have any two-dimensional shape, but do not overlap each other. To partition a training image, one implementation of module 210 uses an image segmentation model that has been pre-trained, using a presently available technique, to recognize objects in images, and group image pixels according to which object the pixels portray. To partition a training image, another implementation of module 210 uses an image segmentation model that has been both pre-trained to recognize objects in images, and group image pixels according to which object the pixels portray, as well as partially trained by an embodiment in a manner described elsewhere herein. To partition a training image, another implementation of module 210, without access to a pre-trained or partially trained image segmentation model, partitions a training image into equal-sized patches, with a patch size or number of patches set according to a predefined parameter or a default. To partition a training image, another implementation of module 210, without access to a pre-trained or partially trained image segmentation model, partitions a training image into randomly located patches, of a random size, where the random numbers are generated using a pseudo-random number generator, a presently available technique. Other techniques for partitioning a training image are also possible.

Patch embedding generation module 220 generates a plurality of patch embeddings. Each patch embedding is a multidimensional numerical representation, or vector, or embedding, of a patch in the plurality of patches of a training image. To generate a patch embedding corresponding to a patch, one implementation of module 220 uses a vision transformer model, a presently available technique, to encode data of the pixels in the patch (e.g., a red value, green value, and blue value if the pixels are in RGB format), as well as data of a position of the patch, and optionally additional data, into an embedding. To generate a patch embedding corresponding to a patch, another implementation of module 220 uses a trained convolutional neural network or another presently available technique.

Training module 250 generates a caption embedding, a multidimensional numerical representation, or embedding, of a natural language caption accompanying the training image for which patch embeddings have been generated. Two non-limiting examples of presently available techniques to generate a caption embedding include using a trained sentence transformer model and converting words in the caption to word embeddings (using a presently available technique such as word2vec) and aggregating the word embeddings together into a caption embedding.

Training module 250 also uses a presently available natural language parsing technique (e.g., a text relation preprocessor) to generate a graph of a natural language caption accompanying the training image for which patch embeddings have been generated. In the caption graph, each node represents an object or other entity described in the caption and each edge (connecting two nodes) represents a relationship between the objects represented by the nodes. Module 250 uses a presently available technique, such as a trained recurrent neural network, to generate one or more word embeddings from the caption embedding and a plurality of node embeddings. Each node embedding is a multidimensional numerical representation, or embedding, of a node in the graph (and hence represents an object described in the caption and present in the training image). Thus, the plurality of word embeddings represents the caption as a whole.

Module 250 trains a patch-label similarity model by computing a similarity between a patch embedding and one or more word embeddings representing graph nodes. One implementation of module 250 uses a cosine similarity, a presently available similarity metric, to compute a similarity between embeddings. Other embedding similarity metrics are also possible. Module 250 stores similarities between patch and word embeddings in a similarity matrix. In the similarity matrix, rows represent patch embeddings, columns represent word embeddings, and a row-column intersection stores a similarity between the row's patch embedding and the column's word embedding. One implementation of module 250 learns the similarity matrix using a fine-grained contrastive learning strategy, using node embeddings as pseudo labels.

Using the similarity matrix, module 250 merges patches that have corresponding node embeddings that are sufficiently similar to each other.

Module 250 uses a pre-trained transformer-based language model, a presently available technique, to train a label prediction model to generate a text label corresponding to the input image. In particular, during training module 250 generates a prompt from a caption graph, and inputs the prompt to a pre-trained transformer-based language model used to train a label prediction model. The label prediction model takes patch embeddings as input and learns, using an auto-regressive generation process, to output text describing the image, including one or more object classes and object labels. Pseudo labels generated by similarity matching is used to supervise the label predictor during training.

Module 250 uses backpropagates the gradient from training the label prediction model to further fine-tune the pre-trained image segmentation model. Module 250 repeats the training image analysis, using additional training image/caption pairs, until the image segmentation model, patch-label similarity model, and label prediction model meet training completion criteria.

Once the image segmentation model, patch-label similarity model, and label prediction model meet training completion criteria, application 200 enters an inference phase. In the inference phase, an input image is parsed without use of an accompanying caption. Instead, image segmentation module 210 uses the trained image segmentation model to partition an input image into a plurality of patches.

Patch embedding generation module 220 generates a plurality of patch embeddings. Each patch embedding is a multidimensional numerical representation, or vector, or embedding, of a patch in the plurality of patches of the input image. To generate a patch embedding corresponding to a patch, one implementation of module 220 uses a vision transformer model, optionally further trained using a training process described herein.

Patch-label similarity module 230 uses the trained patch-label similarity model to generate a plurality of word embeddings corresponding to the plurality of patch embeddings. The trained patch-label similarity model includes a similarity matrix, in which rows represent patch embeddings, columns represent word embeddings, and a row-column intersection stores a similarity between the row's patch embedding and the column's word embedding. Contents of the similarity matrix were learned during a training process described herein. Thus, module 230 uses the learned contents of the similarity matrix to output a word embedding that is most similar to an input patch embedding. The word or phrase represented by the word is thus a label for the patch (and an object within the patch) represented by the patch embedding.

Image labeling module 240 uses a trained label prediction model (optionally further trained using a training process described herein) and the plurality of word embeddings to generate a text label corresponding to the input image. In particular, the trained label prediction model takes, as input, embeddings corresponding to the input image and outputs text describing the image, including one or more object classes and object labels.

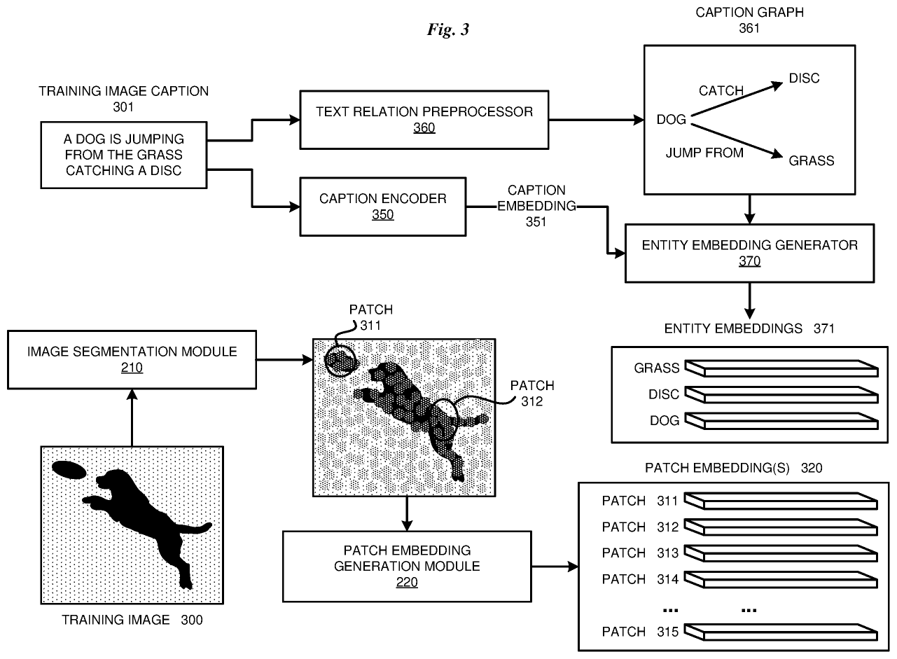

With reference to FIG. 3, this figure depicts an example of scene parsing in accordance with an illustrative embodiment. Image segmentation module 210 and patch embedding generation module 220 are the same as image segmentation module 210 and patch embedding generation module 220 in FIG. 2. The example can be executed using application 200 in FIG. 2.

As depicted, training image 300 and training image caption 301 (describing, in text form, a scene portrayed in training image 300) are being processed. Image segmentation module 210 partitions training image 300 into a plurality of patches, including patches 311, 312, 313, 314, and 315. Patch embedding generation module 220 generates patch embedding(s) 320, each corresponding to one of patches 311, 312, 313, 314, and 315 (as well as other patches that are not depicted). Note that five patches are used purely as an example, and more or fewer patches of a particular image are also possible.

Caption encoder 350 generates caption embedding 351, a multidimensional numerical representation, or embedding, of natural language caption 301. Text relation preprocessor 360 generates caption graph 361, a graph of natural language caption 301. Entity embedding generator 370 uses a presently available technique, such as a trained recurrent neural network, to generate entity embeddings 371 from caption embedding 351 and caption graph 361.

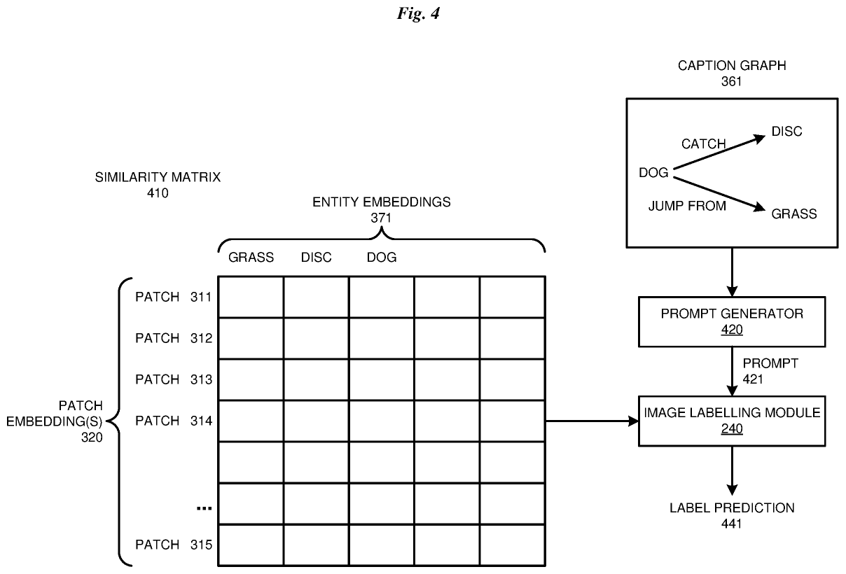

With reference to FIG. 4, this figure depicts a continued example of scene parsing in accordance with an illustrative embodiment. Image labelling module 240 is the same as image labelling module 240 in FIG. 2. Patches 311, 312, 313, 314, and 315, patch embedding(s) 320, caption graph 361, and entity embeddings 371 are the same as patches 311, 312, 313, 314, and 315, patch embedding(s) 320, caption graph 361, and entity embeddings 371 in FIG. 3.

Similarity matrix 410 stores similarities between patch embedding(s) 320 and entity embeddings 371. In similarity matrix 410, rows represent patch embeddings, columns represent word embeddings, and a row-column intersection stores a similarity between the row's patch embedding and the column's word embedding.

Prompt generator 420 generates prompt 421 from caption graph 361. Prompt 421 is an input to a pre-trained transformer-based language model used by image labelling module 240 to train a label prediction model to generate a text label corresponding to an input image. Here, module 240 generates label prediction 441, used to train the label prediction model.

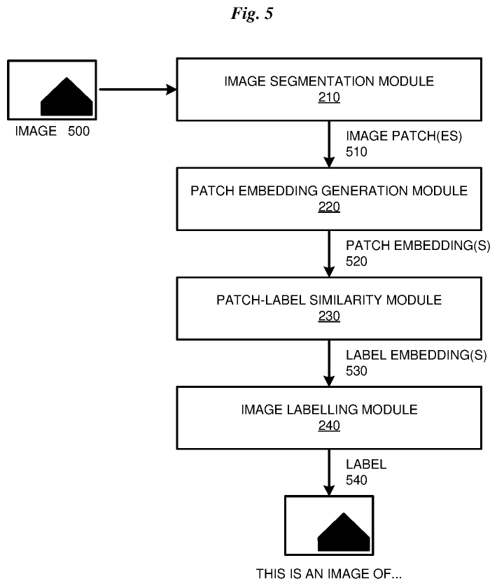

With reference to FIG. 5, this figure depicts a continued example of scene parsing in accordance with an illustrative embodiment. Image segmentation module 210, patch embedding generation module 220, patch-label similarity module 230, and image labelling module 240 are the same as image segmentation module 210, patch embedding generation module 220, patch-label similarity module 230, and image labelling module 240 in FIG. 2.

As depicted, image 500 (without a caption) is being processed in an inference phase. Image segmentation module 210 partitions image 500 into image patch(es) 510. Patch embedding generation module 220 generates patch embedding(s) 520, each corresponding to one of image patch(es) 510. Patch-label similarity module 230 uses the trained patch-label similarity model to generate label embedding(s) 530, a plurality of word embeddings corresponding to patch embedding(s) 520. Image labeling module 240 uses a trained label prediction model (optionally further trained using a training process described herein) and label embedding(s) 530 to generate label 540, a text label corresponding to input image 500.

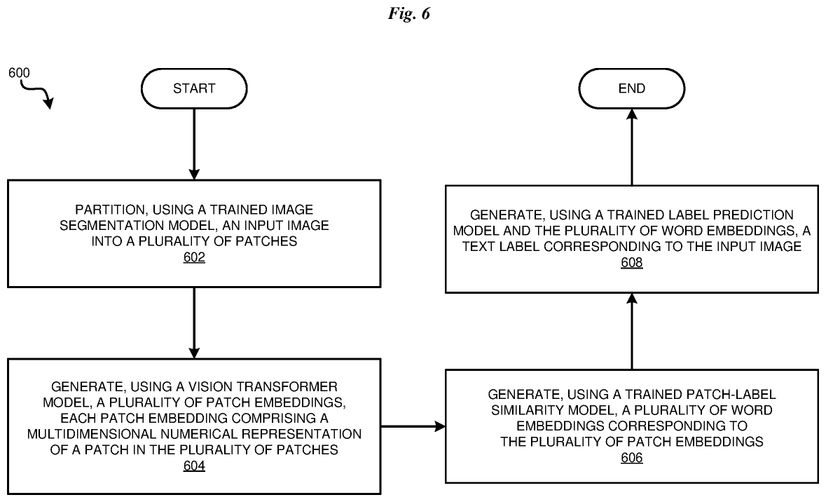

With reference to FIG. 6, this figure depicts a flowchart of an example process for scene parsing in accordance with an illustrative embodiment. Process 600 can be implemented in application 200 in FIG. 2.

In the illustrated embodiment, at block 602, the process partitions, using a trained image segmentation model, an input image into a plurality of patches. At block 604, the process generates, using a vision transformer model, a plurality of patch embeddings, each patch embedding comprising a multidimensional numerical representation of a patch in the plurality of patches. At block 606, the process generates, using a trained patch-label similarity model, a plurality of word embeddings corresponding to the plurality of patch embeddings. At block 608, the process generates, using a trained label prediction model and the plurality of word embeddings, a text label corresponding to the input image. Then the process ends.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
partitioning, using a trained image segmentation model, an input image into a plurality of patches;
generating, using a vision transformer model, a plurality of patch embeddings, each patch embedding comprising a multidimensional numerical representation of a patch in the plurality of patches;
generating, using a trained patch-label similarity model, a plurality of word embeddings corresponding to the plurality of patch embeddings; and
generating, using a trained label prediction model and the plurality of word embeddings, a text label corresponding to the input image.

2. The computer-implemented method of claim 1, wherein the trained patch-label similarity model comprises a similarity matrix, a cell of the similarity matrix storing a pair-wise similarity score between a patch embedding and a word embedding.

3. The computer-implemented method of claim 2, wherein the pair-wise similarity score between a patch embedding and a word embedding is computed by analyzing a plurality of training images and corresponding training image captions.

4. The computer-implemented method of claim 3, further comprising:
partitioning a training image in the plurality of training images into a plurality of training patches; and
generating, using the vision transformer model, a plurality of training patch embeddings, each training patch embedding comprising a multidimensional numerical representation of a training patch in the plurality of training patches.

5. The computer-implemented method of claim 4, further comprising:
generating, from a training image caption corresponding to the training image, a caption graph, each node in the caption graph representing an object described in the training image caption, each edge in the caption graph representing a relationship between two objects represented by nodes in the caption graph;
generating, from a caption embedding and a plurality of node embeddings, a plurality of word embeddings, the caption embedding comprising a multidimensional numerical representation of the training image caption, the plurality of node embeddings each comprising a multidimensional numerical representation of a node in the caption graph; and
computing a pair-wise similarity score between a training patch embedding in the plurality of training patch embeddings and a word embedding in the plurality of word embeddings.

6. The computer-implemented method of claim 5, wherein the trained label prediction model is trained using the plurality of training patch embeddings and the plurality of word embeddings.

7. A computer program product comprising one or more computer readable storage media, and program instructions collectively stored on the one or more computer readable storage media, the program instructions executable by a processor to cause the processor to perform operations comprising:
partitioning, using a trained image segmentation model, an input image into a plurality of patches;
generating, using a vision transformer model, a plurality of patch embeddings, each patch embedding comprising a multidimensional numerical representation of a patch in the plurality of patches;
generating, using a trained patch-label similarity model, a plurality of word embeddings corresponding to the plurality of patch embeddings; and
generating, using a trained label prediction model and the plurality of word embeddings, a text label corresponding to the input image.

8. The computer program product of claim 7, wherein the stored program instructions are stored in a computer readable storage device in a data processing system, and wherein the stored program instructions are transferred over a network from a remote data processing system.

9. The computer program product of claim 7, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

10. The computer program product of claim 7, wherein the trained patch-label similarity model comprises a similarity matrix, a cell of the similarity matrix storing a pair-wise similarity score between a patch embedding and a word embedding.

11. The computer program product of claim 10, wherein the pair-wise similarity score between a patch embedding and a word embedding is computed by analyzing a plurality of training images and corresponding training image captions.

12. The computer program product of claim 11, further comprising:
partitioning a training image in the plurality of training images into a plurality of training patches; and
generating, using the vision transformer model, a plurality of training patch embeddings, each training patch embedding comprising a multidimensional numerical representation of a training patch in the plurality of training patches.

13. The computer program product of claim 12, further comprising:
generating, from a training image caption corresponding to the training image, a caption graph, each node in the caption graph representing an object described in the training image caption, each edge in the caption graph representing a relationship between two objects represented by nodes in the caption graph;
generating, from a caption embedding and a plurality of node embeddings, a plurality of word embeddings, the caption embedding comprising a multidimensional numerical representation of the training image caption, the plurality of node embeddings each comprising a multidimensional numerical representation of a node in the caption graph; and
computing a pair-wise similarity score between a training patch embedding in the plurality of training patch embeddings and a word embedding in the plurality of word embeddings.

14. The computer program product of claim 13, wherein the trained label prediction model is trained using the plurality of training patch embeddings and the plurality of word embeddings.

15. A computer system comprising a processor and one or more computer readable storage media, and program instructions collectively stored on the one or more computer readable storage media, the program instructions executable by the processor to cause the processor to perform operations comprising:
partitioning, using a trained image segmentation model, an input image into a plurality of patches;
generating, using a vision transformer model, a plurality of patch embeddings, each patch embedding comprising a multidimensional numerical representation of a patch in the plurality of patches;
generating, using a trained patch-label similarity model, a plurality of word embeddings corresponding to the plurality of patch embeddings; and
generating, using a trained label prediction model and the plurality of word embeddings, a text label corresponding to the input image.

16. The computer system of claim 15, wherein the trained patch-label similarity model comprises a similarity matrix, a cell of the similarity matrix storing a pair-wise similarity score between a patch embedding and a word embedding.

17. The computer system of claim 16, wherein the pair-wise similarity score between a patch embedding and a word embedding is computed by analyzing a plurality of training images and corresponding training image captions.

18. The computer system of claim 17, further comprising:
partitioning a training image in the plurality of training images into a plurality of training patches; and
generating, using the vision transformer model, a plurality of training patch embeddings, each training patch embedding comprising a multidimensional numerical representation of a training patch in the plurality of training patches.

19. The computer system of claim 18, further comprising:
generating, from a training image caption corresponding to the training image, a caption graph, each node in the caption graph representing an object described in the training image caption, each edge in the caption graph representing a relationship between two objects represented by nodes in the caption graph;
generating, from a caption embedding and a plurality of node embeddings, a plurality of word embeddings, the caption embedding comprising a multidimensional numerical representation of the training image caption, the plurality of node embeddings each comprising a multidimensional numerical representation of a node in the caption graph; and
computing a pair-wise similarity score between a training patch embedding in the plurality of training patch embeddings and a word embedding in the plurality of word embeddings.

20. The computer system of claim 19, wherein the trained label prediction model is trained using the plurality of training patch embeddings and the plurality of word embeddings.
